(19) United States
(12) Patent Application Publication
(10) Pub. No.: US 2012/0253934 A1
(43) Pub. Date: Oct. 4, 2012

(54) SYSTEMS, METHODS, NETWORK ELEMENTS AND APPLICATIONS FOR TARGETED DELIVERY OF PROMOTIONAL MATERIAL

(75) Inventor: Timo Ahopelto, Helsinki (FI)

(73) Assignees: APPLE INC; CVON INNOVATIONS LTD, London (GB)

(21) Appl. No.: 13/058,717

(22) PCT Filed: Aug. 25, 2009
(86) PCT No.: PCT/EP09/60894

§ 371 Date: Oct. 24, 2011

(30) Foreign Application Priority Data
Aug. 26, 2008 (GB) 0815461.9

(51) Int. Cl. G06Q 30/02

(52) U.S. Cl. 705/14.55

(57) ABSTRACT

A method for delivering promotional content to a mobile device user is performed in response to a request from the mobile device user for promotional content pertaining to a specified subject. As part of the method, at least one keyword advertisement inventory including promotional content conventionally delivered via the Internet is accessed to identify promotional content for delivery to the mobile device user. Subsequently, the identified promotional content is reformatted for delivery to the mobile device user in one or more messages including at least one of text and multimedia objects.

### PRIORITY CLAIM

This patent application is a U.S. National Phase of International Patent Application No. PCT/EP2009/060894, filed Aug. 25, 2009, which claims priority to British Patent Application No. 0815461.9, filed Aug. 26, 2008, the disclosures of which are incorporated herein by reference in their entirety.

The invention relates in general to delivery of promotional material via cellular networks. In particular, the invention relates to targeted delivery of Internet-available promotional material to mobile service subscribers via their mobile devices, as specified in the independent claims.

### BACKGROUND

The overwhelming popularity of mobile devices has opened up the possibility of using mobile devices and related communication infrastructure as a media for providing what may be referred to as “mobile marketing” to potential consumers. Mobile marketing involves and relates to marketing and advertising via mobile devices, e.g., mobile phones, smart phones, and Personal Data Assistants (PDAs), or any other computer device configured to be able to receive or send data wirelessly, receiving promotional content, e.g., marketing and/or advertising content in the form of, e.g., text, audio, video or some combination thereof associated with a particular product, service or combination thereof.

Mobile marketing is considered by advertisers as the next new channel to directly reach potential consumers. Mobile marketing enables advertisers to directly reach individual consumers in a targeted way. This is because the nature of mobile media is personal, in that mobile devices are generally used by a particular individual rather than a group of individuals. Further, mobile media is, by definition, mobile, which offers a transportable mechanism for exposing potential consumers to advertising content. Moreover, because mobile media is “always on,” advertisers are not constrained by the need to make a connection in order to deliver promotional content to a user's device because a connection is always established with a user's mobile device (provided the mobile device is in range of an available communication network). As an additional benefit of mobile media as an advertising mechanism, mobile media enables groups of individuals to form wherein the group members communicate actively with each other. As a result, these characteristics combined with social networks-based marketing approach of the Internet may form a very powerful base to execute marketing strategies that is, despite the commonalities, very different from the traditional Internet marketing and its formats.

However, executing such marketing strategies and promotional campaigns is difficult and expensive when mobile marketing functionality is to be delivered to individuals via one or more mobile networks. Additionally, identifying new opportunities for exposing mobile device users to promotional content is increasingly difficult.

### SUMMARY

The following presents a simplified summary in order to provide a basic understanding of some aspects of various invention embodiments. The summary is not an extensive overview of the invention. It is neither intended to identify key or critical elements of the invention nor to delineate the scope of the invention. The following summary merely presents some concepts of the illustrated embodiments in a simplified form as a prelude to the more detailed description below.

In accordance with at least one embodiment of the invention, methodologies and mechanisms are provided that enable methods, systems and software for receiving a request from a mobile device user for promotional content pertaining to a specified subject, accessing at least one keyword advertisement inventory including promotional content conventionally delivered via the Internet to identify promotional content for delivery to the mobile device user and reformatting the identified promotional content for delivery to the mobile device user in one or more messages including at least one of text and multimedia objects, as specified in the independent claims. This is achieved by a combination of features recited in each independent claim. Accordingly, dependent claims prescribe further detailed implementations of the illustrated embodiments.

### BRIEF DESCRIPTION OF THE FIGURES

A more complete understanding of the present invention and the utility thereof may be acquired by referring to the following description in consideration of the accompanying drawings, in which like reference numbers indicate like features, and wherein:

FIG. 1 illustrates an environment wherein embodiments of the invention may be utilized.

FIG. 2 illustrates a method for accessing and delivering promotional content to a mobile subscriber in conjunction with at least one illustrated embodiment.

FIG. 3 illustrates one example of an Advertisement Management System (AMS) utilized in conjunction with at least one illustrated embodiment.

### DETAILED DESCRIPTION OF DISCLOSED EMBODIMENTS

In general, mobile marketing and advertising activities can be divided into four categories: mobile Customer Relations Management (CRM), mobile marketing, mobile advertising, and mobile direct advertising. Mobile CRM involves a combination of mobile advertising, mobile marketing and mobile direct marking (each explained herein) in a manner that establishes a long-term, engaging relationship between a customer or potential customer (i.e., consumer) and a promoting company such as an advertiser of one or more products and/or services.

Mobile marketing involves the systematic planning, implementation and control of a mix of business activities intended to bring together buyers and sellers for the mutually advantageous exchange or transfer of products or services where the primary point of contact with the potential consumer is via their mobile device. To the contrary, mobile advertising may be thought of more narrowly as the paid, public, non-personal announcement of a persuasive message by an identified sponsor (i.e., an advertiser), the non-personal presentation or promotion by a firm of its products to its existing and potential customers where such communication is delivered to a mobile phone or other mobile device. Examples of mobile advertising would include: Wireless Application Protocol (WAP) and Web banner advertisements, mobile search advertising, mobile video bumpers, and interstitial advertisements.

Mobile direct marketing differs from mobile marketing typically in that direct marketing involves advertising content being delivered to a mobile device on an individual basis. Accordingly, examples of mobile direct marketing include the sending of Short Messaging Service (SMS), Enhanced Messaging Service (EMS), Multimedia Messaging Service (MMS), Integrated Messaging Service (IMS) or WAP push messages, Bluetooth messaging and other marketing to mobile devices.

For mobile service providers, having that existing advertising inventory available directly from online would be a significant revenue contributor, if made available easily for mobile subscribers.

However, mobile media is limited by screen size and other qualities, and thus search functionality is not easily converted onto mobile devices. Also, usage scenario is typically different. For example, when online, users browse and search for information; however, when a user is using his mobile device, the user may use the mobile device to complete a specific task, for example find an offer that is attractive. Additionally, mobile device users may browse for information with their mobile devices as a mechanism for passing the time.

Thus, in accordance with at least one embodiment, a system is provided that converts an existing keyword advertisement inventory into messages including text and/or multimedia objects for delivery to mobile service subscribers. Keyword advertising is an established model of advertising in the Internet.

With this understanding of one area of the utility of embodiments of the invention in mind, a description of the architecture and operation of various invention embodiments is now provided.

In accordance with at least one embodiment of the invention, methodologies and mechanisms are provided that enable methods, systems and software for receiving a request from a mobile device user for promotional content pertaining to a specified subject, accessing at least one keyword advertisement inventory including promotional content conventionally delivered via the Internet to identify promotional content for delivery to the mobile device user and reformatting the identified promotional content for delivery to the mobile device user in one or more messages including text and/or multimedia objects

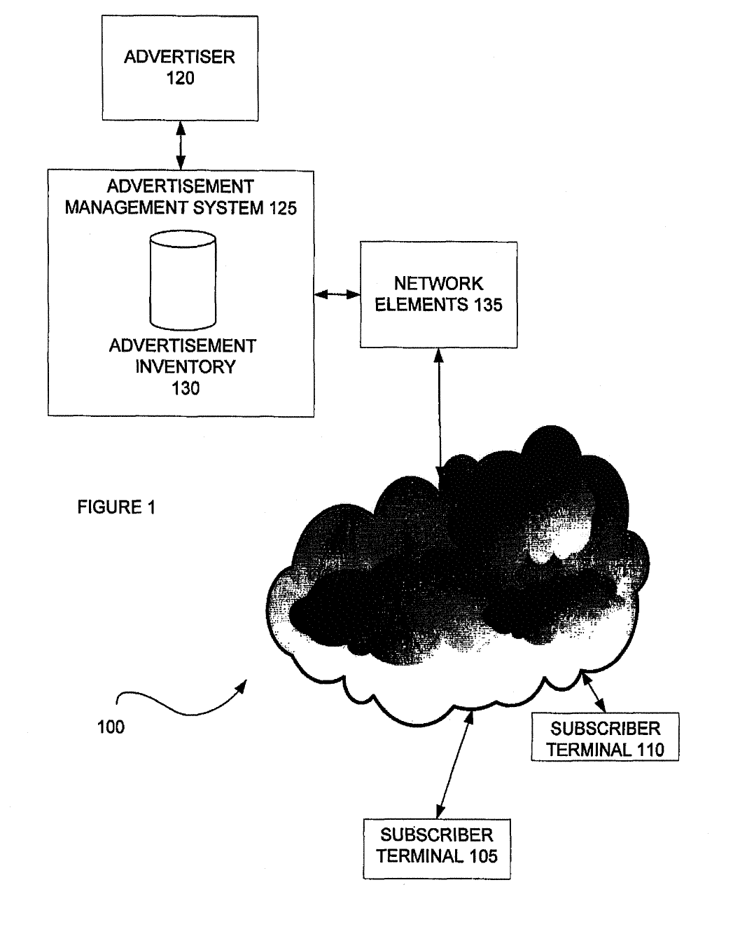

FIG. 1 illustrates an environment 100 wherein embodiments of the invention may be utilized to provide promotional content to mobile service subscribers via a plurality of subscriber terminals 105, 110 via one or more communication networks 115.

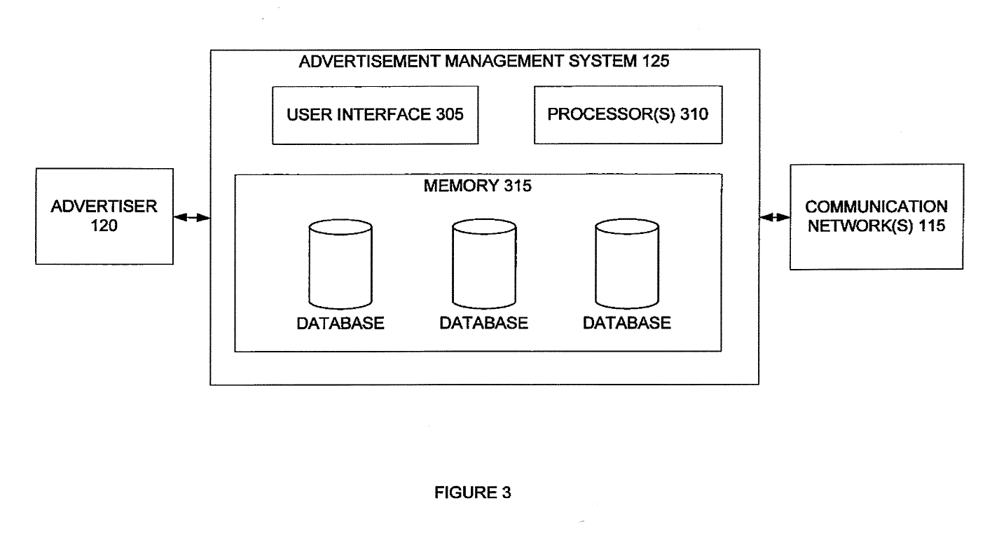

As illustrated in FIG. 1, an advertiser 120 (which may be an advertiser, advertising firm, media agency, operator, consultancy company, promotion company or other similar entity interested in implementing, managing or determining the efficacy of a marketing or advertising campaign) may access an Advertisement Management System (AMS) 125 (also illustrated in further detail in FIG. 3) to manage and control distribution of promotional content in connection with one or more marketing, advertising and/or CRM campaigns. The AMS 125 maintains and manages a keyword advertisement inventory 130 including promotional content conventionally delivered via the Internet 135; thus, the AMS 125 may be maintained by various entities that deliver promotional content via the Internet 135, for example, Google™, Yahoo™, etc.

Promotional content may be distributed to the one or more of the plurality of subscriber terminals 105, 110, which may be, for example, mobile devices or other devices capable of sending and receiving data and messages including text and/or multimedia objects and outputting such messages to the device users. Promotional content included in the keyword advertisement inventory 130 may include, for example, information in the form of data, text, pictures, audio, video, HyperText Markup Language (HTML), extensible Markup Language (XML), extensible HyperText Markup Language (XHTML). However, the promotional content is parsed such that only promotional content deliverable via messages including text and/or multimedia objects is delivered to the subscriber terminals

Moreover, in at least one embodiment, promotional content may be sent in a message that is, for example, an EMS message or an MMS message. Accordingly, it should be understood that promotional content may also include pictures, audio clips, video clips, etc., which may all be sent via MMS and special text formatting (such as bold or italic), animations, pictures, icons, sound effects and special ring tones, which may be sent via EMS.

It should be understood that each of the subscriber terminals 105, 110 can be implemented as a mobile phone, lap top, PDA, multimedia computer, smart phone, etc. Accordingly, although not illustrated, it should be understood that a subscriber terminal 105, 110 may include a processor connected to a user interface, computer readable memory and/or other data storage and a display and/or other output device. The subscriber terminal 105, 110 may also include a battery, speaker and at least one antenna. The user interface may further include a keypad, touch screen, voice interface, one or more arrow keys, joystick, data glove, mouse, roller ball, touch screen or the like.

Accordingly, computer executable instructions and data used by a processor included in a subscriber terminal 105, 110 and other components within a mobile device may be stored in the computer readable memory included in the subscriber terminal 105, 110. Further, the memory may be implemented with any combination of read only memory modules or random access memory modules, optionally including both volatile and non-volatile memory. Further, software may be stored within the memory and/or storage to provide instructions to the subscriber terminal's processor for enabling the mobile device to perform various functions.

Alternatively, some or all of the device computer executable instructions may be embodied in hardware or firmware (not illustrated).

Terminals 105, 110 may have capability to communicate with one or more different types of communication networks and have messaging capabilities including, e.g., a SMS client, electronic mail client or MMS client embedded in the terminal. Terminals 105, 110 may also include a browser (not shown) configured to access Web and/or WAP services.

The one or more communication networks 115 may include any type of communications network including but not limited to a second Generation (2G) network, a 2.5 Generation network, a third Generation (3G) network utilizing GSM, Wideband Code Division Multiplex Access (WCDMA), CDMA, or Time Division Multiplex Access (TDMA), GPRS, Universal Mobile Telephone System (UMTS), etc. Network(s) 115 can also be implemented as a combination of two or more technologies i.e., a hybrid network. Further, in accordance with at least one embodiment, communication network(s) 115 may also include generic Internet access using one or more transport methods.

Further, the one or more communication networks 115 may also include Local Area Networks (LANs), such as Wireless Local Area Networks (WLAN), BlueTooth (BT) and optionally utilize one or more other technologies, such as WiMax (Worldwidelnteroperability for Microwave Access). Communication via the one or more communication networks 115 may be implemented by broadcasting over cellular, broadcasting over DVB-H (Digital Video Broadcasting—Handhelds), ISDB-T (Terrestrial Integrated Services Digital Broadcasting) or DMB (Digital Multimedia Broadcasting).

The one or more communication networks 115 can also include any other type of network of interconnected devices or device networks, e.g., interconnected computers or computer networks. Accordingly, it should be understood that the one or more communication networks 115 can also be a combination of a plurality of different types of networks forming one or more hybrid networks.

The communication network(s) 115 may also include or utilize one or more network elements 135, e.g., Home Location Registers (HLRs), call detail records, SMS centers, MMS centers, WAP gateways, etc. Additionally, the communication network(s) 115 may include or be implemented to communicate with various additional components, e.g., a billing system, base stations and other elements, interfaces and functions conventionally understood to be of use in the operation and provision of a communication network(s). Further, the one or more communication networks 115 may further include one or more base stations or wireless communications station (not shown) installed at fixed locations and used to communicate as part of either a push-to-talk two-way radio system or a wireless telephone system, for example, cellular, CDMA or GSM.

As mentioned above, subscriber terminals 105, 110 may be coupled to or utilize communication network(s) 115, which may be implemented as one or more communication networks and further may be implemented as one or more mobile networks. Therefore, in accordance with at least one embodiment of the invention, the communication network(s) 115 may be connected via a Base Transceiver Station (BTS) (not shown) to a Radio Access Network (RAS) (not shown) included in the one or more communication networks 115. Such a RAS network may include, for example, several BTSs and Base Station Controllers (BTCs); further, such a RAS may be implemented via connection to components located at one or more facilities associated with or controlled by an operator, such as a level operator and/or network provider that incorporates or is connected to or coupled to various network elements, for example, a Visiting Mobile Switch Center (VMSC) (not shown), Gateway Mobile Switch Center (GWMSC) (not shown), Home Location Register (HLR) (not shown), and billing system (not shown).

In accordance with at least one embodiment of the invention, the AMS 125 may be configured to operate as a mechanism for receiving promotional content and instructions on distributing promotional content to consumer/customers, as well as receive such content and manage the delivery of such content via the communication network(s) 115. However, the functionality necessary for managing delivery of promotional content may be resident in the one or more network elements 135 provided in the communication network(s) 115.

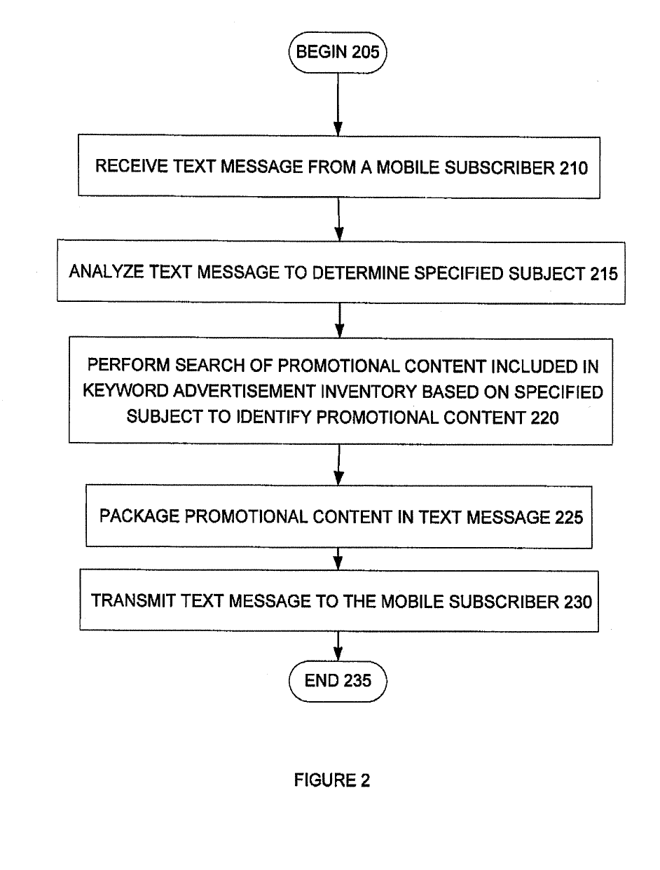

As illustrated in FIG. 2, a method is provided for converting an existing advertisement inventory into mobile messages including text and/or multimedia objects for delivery to mobile service subscribers. As shown in FIG. 2, the method begins at 205 and control proceeds to 210 at which a message, e.g., an SMS message, MMS message, IMS message, etc. is received from a mobile subscriber. This message may be received, for example, at a designated alphanumeric number, e.g., a short number such as “101010.”. The designated phone number may be, conceptually considered to be the “offer channel” for a promotional content delivery service provided in accordance with the illustrated embodiments. Such channels may be general channels, through which a mobile subscriber can receive promotional content on various different subjects. Alternatively, such channels may be specific to a particular type of promotional content, e.g., promotional content specific to Detroit, Michigan, or promotional content regarding a particular company, a particular brand, a particular product, a particular type of product, a particular individual, a particular movie, a particular television show, a particular sport, a particular team, a particular musical group, a particular celebrity, etc.

Thus, such a message may include an indication of one or more subjects that the mobile subscriber is interested in receiving promotional content, for example, advertisements, special offers, text-to-win campaigns, click-to-win or click-to-buy links, etc. For example, the message could include the name “Miley Cyrus” (a popular celebrity).

Returning to FIG. 2, at 215, the received message is analyzed to identify the type of promotional content requested by the mobile subscriber. Subsequently, at 220, the identified specified subject information included in the message is used to perform a search of promotional content included in a keyword advertisement inventory. Such inventories may include, for example, Google's Adwords™ inventory or the Adsense™ inventory or any other conventionally available inventory of promotional content that may be accessed and/or searched using keywords that identify subject matter, duration, or other promotional content specific attributes.

The operations performed at 220 may be performed in various alternative configurations but substantially correspond to keyword searching of advertisement inventories conventionally performed by Internet search engines. Such keyword advertisement searches are performed by search engines such a Google™ and Yahoo™ for the purpose of identifying and displaying advertisements in conjunction with delivery of search results to an individual using the search engine service. Thus, by performing the operations specified at 220, it is possible to identify advertisements and other content (generically referred to as promotional content) that may be of interest to the mobile subscriber who sent the message to the offer channel at 215.

As part of the operations performed at 220, a number of promotional content filters may be utilized as part of the keyword advertisement inventory search. For example, a characterizing keyword like “offer” may be added to the search to signify that the mobile subscriber is interested in receiving offers specific to the keyword included in the message; therefore, searching the keyword advertisement inventory for “offer Webkins™” may be tailored to provide promotional content specific to special offers for Webkins™ products (a popular children's toy). Additionally, the resulting promotional content may be further filtered based on a mobile subscriber's ability to immediately access the special offers. Thus, for example, promotional content may be ordered first if they have click-to-buy or click-to-call functionality within the content.

Once the promotional content is identified at 225, control proceeds to 225, at which the promotional content is packaged in a message that may include text and/or multimedia objects, e.g., SMS, MMS, EMS, IMS, IM messages, etc. Operations performed at 225 may include the removal certain content that is inappropriate for inclusion in a text message and/or replacement or reformatting of some or all of the promotional content with corresponding text. The message may include, for example, a click-to-buy or click-to-call data so as to be available to the mobile subscriber once the message is received.

Control then proceeds to 230, at which the message is transmitted to the mobile subscriber that requested the promotional content. Subsequently, control proceeds to 235, at which the operations end.

Although not illustrated, it should be understood that the operations performed at 225 and 230 in FIG. 2 may be performed repeatedly, for example, on a periodic basis, e.g., daily or during periods of time set by system operators, service subscribers, etc.

The illustrated embodiments may have utility in various different mobile service environments. However, particular utility may be provided when the embodiments are used to provide a service for identifying special offers of particular interest to mobile service subscribers. Thus, if a mobile service subscriber is interested in receiving such a Special Offers Search (SOS) service, the mobile service subscriber may simply send a message to a designated short number and identify the types and subject of special offers the subscriber is interested in.

Such a service may be provided in conjunction with, for example, a mobile service (e.g., mobile phone, texting, instant messaging, etc) that is provided to subscribers at a reduced cost or at no cost in return for the mobile service subscribers agreeing to be exposed to promotional content from one or more advertisers. Thus, subscribers to such a reduced or no cost mobile service members may be instructed to text in keywords of products that they would like to see special offers on. In response, the subscriber receives various types of promotional content, e.g., click-to-call numbers, Wireless Application Protocol (WAP) links, etc. with accompanying keyword advertisements.

It should be appreciated that that sending of messages including text and/or multimedia objects to such an SOS service may be free for some subscribers (e.g., subscribers that opt into the service) or all mobile service subscribers. Moreover, subscribers sending such messages including text and/or multimedia objects or opting into the SOS service may be compensated for doing so by receiving credit to their mobile service subscription account or to a different account in connection with the SOS service.

It should be appreciated that the functionality and operations performed in conjunction with the illustrated embodiments may be performed in whole or in part by one or more different entities, organizations, computer applications or systems. Thus, it should be appreciated that the operations performed to search a keyword advertisement inventory may be performed by a different entity, organization, computer application or system then those operations performed to receive promotional content requests from mobile subscribers and ultimately send the identified promotional content to the mobile subscribers. For example, it should be appreciated that an organization operating the AMS and maintaining the keyword advertising inventory illustrated in FIG. 1 may be different than the organization that is responsible for receiving queries for or coordinating delivery of promotional content to the mobile subscribers.

However, regardless of whether only one organization or multiple organizations are cooperating to provide functionality of the invention, FIG. 3 illustrates one example of the components of the AMS 125 in more detail. Preferences, settings, and promotional content and/or other rules of distributing promotional content may be stored in memory 315. Promotional content may be commercial, e.g., product or service promotion or non-commercial messages such as general information services.

Once an advertiser has provided data indicating what, when and how promotional content is to be distributed (e.g., the content, format and events triggering delivery of the promotional content) in connection with a marketing, advertising or CRM campaign, the information may be used to deliver the promotional content via the one or more communication networks 115 to one or more subscriber terminals 105, 110.

The AMS 125, alone or in combination with the one or more network. elements 135 included in the communication networks 115 may be configured to access, manage and/or store data used in the management and delivery of promotional content to one or more subscriber terminals 105, 110. For example, one or more databases may be utilized including customer records and data indicating relationship history such as orders, offers, and customer information, e.g., customer phone numbers, addresses, etc.

As illustrated in FIG. 3, the AMS 125 may include one or more processors 305 operationally coupled to a user interface 310, computer readable memory and/or other data storage 315. Accordingly, computer executable instructions and data used by the processor(s) 305 and other components within the AMS 125 may be stored in the computer readable memory included the AMS 125. Further, software may be stored within the memory and/or storage 315 (coupled to the processor(s) 305 and user interface 310) to provide instructions to the AMS components for enabling promotional content selection from one or more keyword advertisement inventories.

For example, the AMS 125 may be configured to receive promotional content (e.g., audio, video, text, graphics, font type, font color, etc.) and format of the promotional content (e.g., MMS, EMS, SMS, IMS, WAP push, etc.) associated with marketing and/or advertising campaigns as well as other details regarding distribution of such promotional content via the user interface 310. Subsequently, that information may be stored in one or more databases included in the computer readable memory and/or other data storage 315. Accordingly, the user interface 310 may be configured to enable an advertiser 10 or other entity to interact with components of the AMS 125 as well as other systems and components and network elements 135 configured to manage and control distribution of promotional content and further components configured to analyze responses thereto as part of one or more marketing, advertising or customer relations campaigns. Accordingly, the user interface 310 may be implemented as a web-based user interface provided by software stored in the memory 315 or running on one or more servers associated with or supporting the AMS 125.

The memory 315 may include one or more databases configured to store promotional content, advertiser preferences for distributing promotional content, an archive of promotional content previously sent to a plurality of users and their respective responses to such advertising content as well as the type of promotional content, rules for selecting promotional content for distribution content, etc. Additionally, the memory 315 may also include one or more databases for storing actual promotional content and related distribution parameters for use in distributing the promotional content in connection with campaigns.

It should be understood that memory 315 may include many databases that separately include, for example, user profile information (including information about subscriber terminals), promotional content, archive data, etc. or some combination or all of this information and data may be included in a single database.

Promotional content may be selected by various other schemes to ensure that the content is acceptable, persuasive and/or of interest to those receiving it. Therefore, promotional content may be selected by various schemes including, e.g., combining device user profiles (which may indicate, for example, information about the recipients geographic location, demographic information including age, gender, interests, etc) and preferences with advertisers' target profiles (e.g., demographic information provided by an advertiser regarding target audience for promotional content and delivery preferences). In accordance with at least one embodiment of the invention, matching promotional content may also or alternatively be selected by a round robin scheme, first reserve first serve, randomly etc.

Additionally, a history of promotional content transmitted to a particular user/subscriber may be stored and archived (e.g., in memory 315 of AMS 125 illustrated in FIG. 3). As a result, an understanding of interests of a particular user/subscriber could be gained and used to enhance relevance of promotional content transmitted to the subscriber (e.g., archived content indicates that a subscriber is interested in horror movies, is interested in foreign films, is interested in music concerts, etc.) Further, analysis of promotional content to be transmitted may be performed in whole or part using special application software running in a mobile le device.

Additionally, as explained above, in accordance with at least one embodiment of the invention, costs for cellular phone services may be free or subsidized based on user interaction with distributed promotional content. Such services may include one or more voice services (i.e., making and receiving phone calls), messaging services such as SMS, MMS, using data services such as Internet browsing or WAP browsing, making video calls, downloading content, streaming content, purchasing applications such as games or other software, using location services, finding information, communicating with a group of people (e.g., multicast communication), etc.

Moreover, although not specifically illustrated or discussed above, one or more of the above-described components (e.g., AMS 125 illustrated in FIGS. 1 and 3) or additional elements may be included in the network 100 that operate or cooperate to identify a correlation between the accessing of a particular content service from a mobile terminal and the transmission of promotional content including a hyperlink. In such an implementation, a “click-thru” type of billing model for distributing promotional content would, therefore, be feasible. Additionally, such an implementation may also enable a business or pricing model wherein, services provided via one or more networks may be provided to a user at a reduced, free or subsidized rate.

While this invention has been described in conjunction with the specific embodiments outlined above, it is evident that many alternatives, modifications and variations will be apparent to those skilled in the art. Accordingly, the various embodiments of the invention, as set forth above, are intended to be illustrative, not limiting. Various changes may be made without departing from the spirit and scope of the invention.

For example, it should be understood that the term “promotional content” may include various types of advertising material including any one of or combination of text, pictures, audio, video, links to web-sites or other locations of information, telephone numbers, electronic mail addresses, downloadable files including but not limited to audio files including ring tones, songs, etc, computer implemented games, video files, etc. Also, it should be understood that the term “promotional content” includes any type of content provided in connection with mobile marketing, mobile advertising or other material provided for the purpose of persuading mobile device users.

Moreover, it should be understood that the promotional content identified in the keyword advertisement inventory may be on a subject that is different but related to the subject specified by the mobile subscriber. Therefore, in one alternative embodiment, although the mobile subscriber may receive special offers regarding a particular brand of computer game player equipment, additional promotional content may be sent to the mobile subscriber regarding new computer games that may be played on the specified brand of computer game player equipment.

Additionally, it should be understood that the functionality described in connection with various described components of various invention embodiments may be combined or separated from one another in such a way that the architecture of the invention is somewhat different than what is expressly disclosed herein. Moreover, it should be understood that, unless otherwise specified, there is no essential requirement that methodology operations be performed in the illustrated order; therefore, one of ordinary skill in the art would recognize that some operations may be performed in one or more alternative order and/or simultaneously.

Various components of the invention may be provided in alternative combinations operated by, under the control of or on the behalf of advertisers, advertising channel provider(s), network providers, marketing organizations, etc.

In the above description of the various illustrated embodiments, reference is made to the accompanying drawings, which form a part hereof, and in which is shown, by way of illustration, various embodiments in which the invention may be practiced. It is to be understood that other embodiments may be utilized and structural and functional modifications may be made without departing from the scope of the present invention.

Moreover, it should be understood that various connections are set forth between elements in the above description; however, these connections in general, and, unless otherwise specified, may be either direct or indirect, either permanent or transitory, and either dedicated or shared, and that this specification is not intended to be limiting in this respect.

Further, it should be understood that, in accordance with at least one embodiment of the invention, system components may be implemented together or separately and there may be one or more of any or all of the disclosed system components. Further, system components may be either dedicated systems or such functionality may be implemented as virtual systems implemented on general purpose equipment via software implementations.

Additionally, it should be appreciated that a request for promotional content may be generated by the mobile subscriber or generated automatically or semi-automatically by a subscriber's mobile device as part of a subscription service, e.g., the SOS service, or as part of software configured to track the mobile subscriber's preferences.

Finally, although the above the description refers to promotional content, advertisements, advertisement inventory, etc., it should be understood that the term promotional content may include text, graphics, links, sound, video, etc. associated with mobile marketing regardless of the product or service being advertised. Therefore, the term promotional content includes advertisements included in the keyword advertising inventory discussed above.

As a result, it will be apparent for those skilled in the art that the illustrative embodiments described are only examples and that various modifications can be made within the scope of the invention as defined in the appended claims.

1. A method for identifying promotional content for delivery to at least one mobile device, the method comprising:
receiving a request from a mobile device for promotional content pertaining to a specified subject;
triggering access of one or more promotional content inventories including promotional content configured for delivery via the Internet based on the specified subject to identify promotional content for delivery to the mobile device; and
reformatting the identified promotional content for delivery to the mobile device in one or more messages including at least one of text and multimedia objects.

2. The method of claim 1, wherein the promotional content includes at least one special offer specific to the specified subject.

3. The method of claim 1, wherein the promotional content request is included in a text message.

4. The method of claim 1, wherein the one or more messages is a Short Message Service message.

5. The method of claim 1, wherein the one or more messages is a text message.

6. The method of claim 1, wherein the one or more messages is a Multimedia Message Service message.

7. The method of claim 1, wherein the one or more messages is an Enhanced Message Service message.

8. The method of claim 1, further comprising transmitting the reformatted promotional content to the mobile device.

9. The method of claim 1, wherein the promotional content includes a click-to-buy link.

10. The method of claim 1, wherein the promotional content includes a click-to-win link.

11. The method of claim 1, wherein the promotional content includes a link that, when selected, opens a browser on the mobile device and directs the mobile device to a specific address on the Internet.

12. The method of claim 1, wherein the promotional content includes a click-to-call link.

13. The method of claim 1, wherein the identified promotional content relates to the specified subject.

14. The method of claim 13, wherein the identified promotional content pertains to a subject that is different but related to the specified subject.

15. The method of claim 1, wherein the identified promotional content is reformatted prior to transmission to the mobile device based on a number through which the request was sent by the mobile device.

16. The method of claim 1, wherein the identified promotional content is reformatted prior to transmission to the mobile device based on mobile device subscriber specific information.

17. The method of claim 16, wherein the mobile device subscriber specific information is a location of the subscriber.

18. The method of claim 16, wherein the mobile device subscriber specific information is demographic information specific to the subscriber.

19. A system configured to identify promotional content for delivery to at least one mobile device, the system comprising:
at least one network element configured to receive a request from a mobile device for promotional content pertaining to a specified subject; and
an advertisement management system configured to access one or more promotional content inventories including promotional content configured for delivery via the Internet based on the specified subject to identify promotional content for delivery to the mobile device;
wherein the at least one network element and advertisement management system cooperate to reformat the identified promotional content for delivery to the mobile device in one or more messages including at least one of text and multimedia objects.

20. The system of claim 19, wherein the promotional content includes at least one special offer specific to the specified subject.

21. The system of claim 19, wherein the promotional content request is included in a text message.

22. The system of claim 19, wherein the one or more messages is a Short Message Service message.

23. The system of claim 19, wherein the one or more messages is a text message.

24. The system of claim 19, wherein the one or more messages is a Multimedia Message Service message.

25. The system of claim 19, wherein the one or more messages is an Enhanced Message Service message.

26. The system of claim 19, wherein the at least one network element is configured to transmit the reformatted promotional content to the mobile device.

27. The system of claim 19, wherein the promotional content includes a click-to-buy link.

28. The system of claim 19, wherein the promotional content includes a click-to-win link.

29. The system of claim 19, wherein the promotional content includes a link that, when selected, opens a browser on the mobile device and directs the mobile device to a specific address on the Internet.

30. The system of claim 19, wherein the promotional content includes a click-to-call link.

31. The system of claim 19, wherein the identified promotional content relates to the specified subject.

32. The system of claim 31, wherein the identified promotional content pertains to a subject that is different but related to the specified subject.

33. The system of claim 19, wherein the identified promotional content is reformatted prior to transmission to the mobile device based on a number through which the request was sent by the mobile device.

34. The system of claim 19, wherein the identified promotional content is reformatted prior to transmission to the mobile device based on mobile device subscriber specific information.

35. The system of claim 34, wherein the mobile device subscriber specific information is a location of the subscriber.

36. The system of claim 34, wherein the mobile device subscriber specific information is demographic information specific to the subscriber.

37. A system configured to identify promotional content for delivery to at least one mobile device, the system comprising:
at least one network element configured to receive a request from a mobile device for promotional content pertaining to a specified subject and configured to trigger an advertisement management system to access one or more promotional content inventories including promotional content for delivery via the Internet based on the specified subject to identify promotional content for delivery to the mobile device, wherein the at least one network element is configured to cooperate with the advertisement management system to reformat the identified promotional content for delivery to the mobile device in one or more messages including at least one of text and multimedia objects.

38. A computer readable medium comprising computer executable instructions for carrying out a method for identifying promotional content for delivery to at least one mobile device, the method comprising:
receiving a request from a mobile device for promotional content pertaining to a specified subject;
triggering access of one or more promotional content inventories including promotional content configured for delivery via the Internet based on the specified subject to identify promotional content for delivery to the mobile device; and
reformatting the identified promotional content for delivery to the mobile device in one or more messages including at least one of text and multimedia objects.
